(19) United States
(12) Patent Application Publication
(10) Pub. No.: US 2006/0153196 A1
(43) Pub. Date: Jul. 13, 2006

(54) Systems and methods for achieving improved ADSL data rates over USB 1.1 channel

(75) Inventors: Waldemar Diaz, Barnegat, NJ (US); Kamal Patel, Freehold, NJ (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Conexant Systems, Inc., Red Bank, NJ (US)

(21) Appl. No.: 11/032,203

(22) Filed: Jan. 11, 2005

(51) Int. Cl. H04L 12/28

(52) U.S. Cl. 370/395.1

(57) ABSTRACT

A system for achieving improved isochronous downstream data throughput rates between a DSL modem and a destination device, such as a PC, over a USB 1.1 data channel. An asynchronous transfer mode signal is received by a DSL modem. After normal signal processing, a controller in the modem executes a compression algorithm to strip the redundant ATM header information from each cell. A serial data stream containing the compressed ATM cells are then transferred to the destination device over USB 1.1 channel. A software driver stored at the destination device decompresses the compressed ATM signals for normal reassembly. Because only the data payload portion of each ATM cell is transferred to the destination device, the full 8.184 Mbits/s of the USB channel is used to transfer data, thereby increasing the effective data throughput rate.

### FIELD OF THE INVENTION

The present invention relates to systems and methods for electronic data transmission over an ATM network and more particularly to systems and methods for eliminating the USB download bottleneck for DSL modems through ATM cell header compression.

### BACKGROUND OF THE INVENTION

Asymmetric digital subscriber lines (ADSL) are high speed dedicated lines for interfacing with a communications network such as the Internet. Unlike dialup service, which requires re-establishing a connection every use, DSL may remain permanently connected to the network. Also, unlike dialup, through allocation of the frequency spectrum, DSL is capable of simultaneously carrying telephone and two-way data over the same line. The total available bandwidth on an existing copper telephone wire is divided unequally among voice and data. Because telephone sampling rates are on the order of a few kilohertz, both voice and data signals can coexist without interference. For example, voice gets the low end allocation (300 Hz to 3.3 Hz), then data uploads get the next allocation (20K to 138K Hz) and data downloads get the remaining allocation (150K Hz to 1.1 MHz) up to the maximum frequency. Asymmetric DSL refers to a the fact that the allocation of frequency spectrum is skewed asymmetrically with data downloads receiving the largest allocation. Because DSL is a service provided over an existing phone line, users simply connect their computers to their regular phone line through a DSL modem.

DSL modems transmit and receive data to and from a carrier switch called a DSL access multiplexer (DSLAM) that serves as a gateway to a network. The format of the signal between the modem and the switch is dependent on the carrier providing the DSL service. There are currently several standard compliant versions of ADSL, including ITU G.992.1 (G.DMT) Annex A, Annex B, and Annex C, ITU G.992.2 (G.Lite) Annex A and Annex C, and ANSI T1.413 Issue 2. Current DSL download speeds using existing DSL modems are up to 9 Mbits/s and upload speeds are up to 1 Mbits/s.

A common protocol for transferring information over digital information networks is asynchronous transfer mode (ATM). ATM is a protocol in which digital information is organized into fixed length cells for efficient transmission over the network. Each cell contains a header and a data payload. ATM provides scalable bandwidth from a few megabits per second (Mbps) to many gigabits per second (Gbps). Because ATM is asynchronous, it is more efficient than synchronous technologies, such as time-division multiplexing (TDM). In TDM, each user is assigned to a time slot, and no other station can send in that time slot. If an individual station has a large amount of data to send, it can only send it during its time slot. If, however, the station has no data to send, the time slot is unused. In ATM, time slots are available on demand. Instead of being correlated to a timeslot, information identifying the source of the transmission is contained in the header of the individual cells.

During uploads, a DSL modem transmits a data stream of ATM cells from an end node application running, for example, on a personal computer (PC), to the carrier switch. Using information stored in the ATM cell headers, ATM routers and switches deliver the ATM cells to a destination. During download, the DSL modem receives and transforms a series of ATM cells into a data stream and sends it to a computer or other device over a data channel. The data may be, for example, text, video or audio data.

A typical DSL modem includes DSL software and hardware for formatting to and recovering data from cells communicated over the DSL line, and connection protocol hardware for communicating with a computer. One popular communications protocol for interfacing a DSL modem with a PC is the universal serial bus (USB). The USB is a plug-and-play interface between a computer and external devices such as storage devices, mice, printers, cameras and modems. With the USB protocol, devices can be added to a computer using a simple inexpensive four-wire cable without restarting or having to install driver software. Using USB drivers stored in the operating system, the USB allows the computer to recognize devices connected over the USB bus and to install any device-specific drivers in real time. The USB has the additional advantage that separate power adapters are not required for the individual devices connected to the USB bus because the bus determines the amount of power required and supplies it to the device.

Under the USB 1.1 standard, also known as full speed USB, USB-type ADSL modems have a maximum isochronous (real time) downstream data speed of up to 8.184 Mbits/s. Current ADSL modems are capable of data downstream speeds slightly higher than this, and future ADSL modems are expected to be even more robust. Thus, the USB 1.1 channel becomes the limiting factor for future increases in DSL downstream data speeds. As ADSL modem rates increase to 16 Mbits/s and higher, the USB 1.1 bus will remain an 8.184 Mbits/s bottleneck. Moreover, because USB-type DSL modems transfer ATM cells over the USB channel, some of the already limited bandwidth is being used to transfer header information, reducing the effective bandwidth by the ratio of the header information to the data payload for each ATM cell.

Thus, there is a need for increasing the efficiency, speed, or both, of data transfer between a PC and a DSL modem over the USB 1.1 channel.

### SUMMARY OF THE INVENTION

The present invention mitigates or solves the above-identified limitations in known solutions, as well as other unspecified deficiencies in known solutions. A number of advantages associated with the present invention are readily evident to those skilled in the art, including economy of design and resources, transparent operation, cost savings, etc.

Disclosed herein are various exemplary mechanisms for achieving improved downstream ATM data throughput rates from a DSL modem over a USB version 1.1 data channel. Also disclosed herein are various exemplary mechanisms for compressing ATM cell header information to increase data payload throughput.

In accordance with one embodiment of the present invention, a method for compressing an ATM data signal with a DSL modem and transferring the data at an improved data rate over a USB 1.1 bus is provided. The method comprises the steps of receiving a downstream ATM signal with the modem, compressing the cells by stripping the ATM header information from each cell, and sending the compressed data signal as a serial data stream over the USB 1.1 bus to the PC for decompression and reassembly.

In accordance with another embodiment of the present invention, a method for decompressing an ATM data signal with a computer is provided. The method comprises the steps of receiving the compressed data signal as a serial data stream over a USB 1.1 bus, decompressing the signal using a decompression algorithm contained in one or more software drivers and reassembling the original data signal.

In accordance with an additional embodiment of the present invention, a USB bus powered chipset for a DSL modem is provided. The chipset comprises an analog front end (AFE), a digital signal processor (DSP), a controller for executing a compression algorithm and a USB 1.1 interface.

In accordance with yet another embodiment of the present invention, a bus powered ADSL modem is provided. The ADSL modem comprises an AFE, a DSP, a controller for executing a compression algorithm, and a USB interface.

In accordance with an additional embodiment of the present invention, a computer readable storage medium storing a set of computer readable instructions which, when executed by a processor, will decompress a serially transmitted compressed ATM signal is provided. The computer readable storage medium comprises a plurality of executable instructions that are adapted to manipulate a processor to receive a USB-based data stream of compressed ATM cells, decompress the ATM cells and perform reconstruction of the original data signal.

Still further features and advantages of the present invention are identified in the ensuing description, with reference to the drawings identified below.

### BRIEF DESCRIPTION OF THE DRAWINGS

The purpose and advantages of the present invention will be apparent to those of ordinary skill in the art from the following detailed description in conjunction with the appended drawings in which like reference characters are used to indicate like elements, and in which:

FIG. 1 is an illustration of an exemplary ATM network in accordance with at least one embodiment of this invention;

FIG. 2 is illustrates an exemplary ATM cell in accordance with at least one embodiment of this invention;

FIG. 3 is a bitwise illustration representing an ATM cell header formatted for a user to network interface (UNI) in accordance with at least one exemplary embodiment of this invention;

FIG. 4 is a bitwise illustration representing an ATM cell header formatted for a network node interface (NNI) in accordance with at least one exemplary embodiment of this invention;

FIG. 5 is a block diagram illustrating segmentation and reassembly of a series of ATM cells in accordance with at least one embodiment of the present invention;

FIG. 6 is a block diagram illustrating the internal hardware components of an exemplary ATM DSL modem capable of providing improved data throughput rates over a USB 1.1 channel in accordance with at least one embodiment of the present invention;

FIG. 7 is a high level block diagram of the software components for increasing the data throughput rate between a computer and DSL modem over a USB 1.1 channel in accordance with at least one embodiment of the present invention;

FIG. 8 is a flow chart illustrating the steps of a method for improving the data throughput rate between a DSL modem and a destination device over a USB 1.1 channel in accordance with at least one embodiment of the present invention; and

FIGS. 9 and 10 are block diagrams illustrating functional steps of compressing and reassembling an ATM cell in accordance with at least one embodiment of the present invention.

### DETAILED DESCRIPTION OF THE INVENTION

The following description is intended to convey a thorough understanding of the present invention by providing a number of specific embodiments and details involving data transmission of ATM cells from a DSL modem to a personal computer (PC) over a USB 1.1 data channel. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

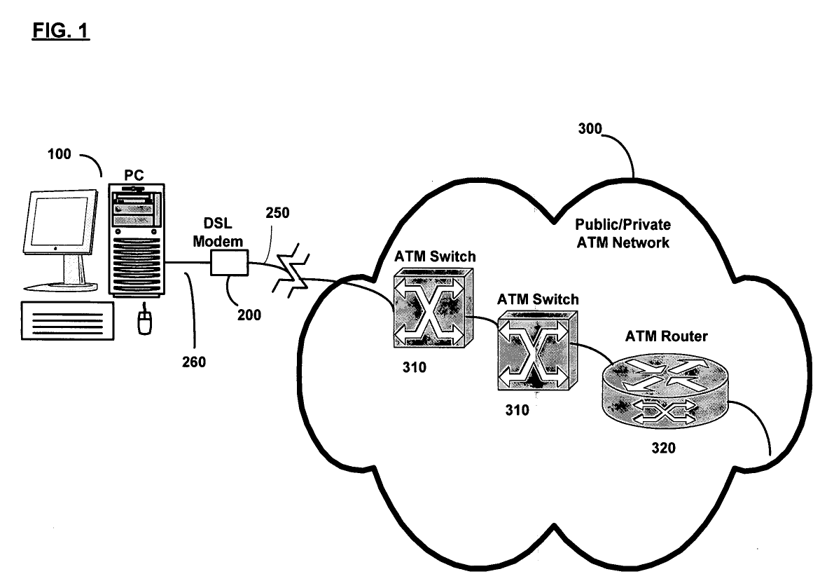

FIG. 1 illustrates an exemplary ATM-based communication network comprising an end node, in this case a personal computer (PC) 100, connected to a DSL modem 200 over a USB 1.1 channel 260. The modem 200 sends and receives data over a digital subscriber line (DSL) 250 which is connected to a carrier switch (not shown) which, in turn, is connected to a public or private ATM network 300. The network consists of a series of ATM switches 310 and ATM routers 320 which,—based on information contained in the ATM cell header, transfer data across the network 300.

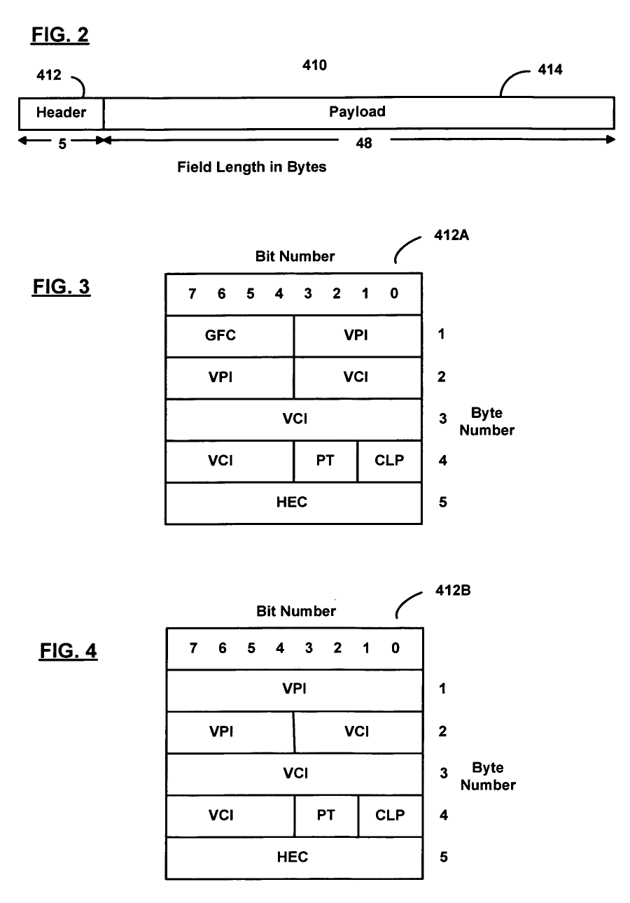

FIG. 2 illustrates an exemplary ATM cell 410 having a fixed length of 53 bytes, also known as octets (8 bits each). The first 5 bytes of the cell 410 are known as the ATM cell header 412. The ATM cell header 412 typically contains information fields describing the data in the cell 410, as well as origination and destination information. The remaining 48 bytes are known as the data payload 414. The data payload 414 portion of the cell 410 carries the actual data to be transported as a cluster of 8 bit words. ATM cell headers are formatted in one of two possible configurations depending upon whether the cell is being transmitted from an end node or if the cell is being transmitted between switches in a network.

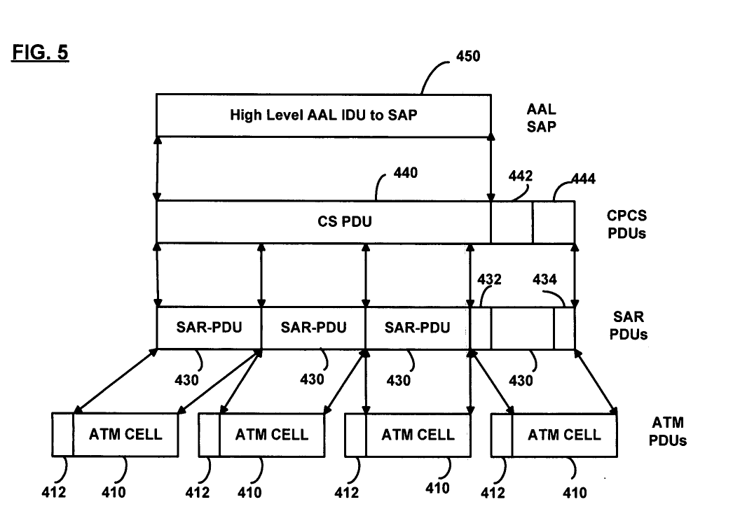

FIGS. 3 and 4 are bitwise illustrations of the two exemplary types of ATM cell headers 412A and 412B formatted for a user to network interface (UNI) and a network node interface (NNI) respectively. The primary difference between the two header types is the inclusion of the 4 bit generic flow control (GFC) field in the UNI-type header 412A. The GFC header field is used for local functions, such as identifying multiple stations that share a single ATM interface. This field is typically not used and is set to its default value. Because this field is not included in NNI-type headers, it does not affect incoming traffic flow and thus, is not needed at the receiving end. The virtual path identifier (VPI) and virtual channel identifier (VCI) header fields contain information identifying the next destination of a cell as it passes through a series of ATM switches on the way to its destination. These fields are updated by each switch the cell passes through. The payload type (PT) header field is a 3 bit field that indicates the nature of the data in the payload. The first bit of the PT header field indicates whether the cell contains user data or control data. If the cell contains user data, the second bit indicates congestion, and the third bit indicates whether the cell is the last in a series of cells that represent a single ATM adaptation layer five (AAL5) frame. The congestion loss priority field (CLP) is a single bit field that indicates whether the cell should be discarded if it encounters extreme congestion as it moves through the network. If the CLP bit equals one, the cell should be discarded in preference to cells with the CLP bit equal to zero. The fifth and final byte of the ATM cell header is the header error control field (HEC). The HEC field uses a cyclic redundancy check as an error detector on the cell header alone. The transmitter calculates the HEC value on the first four bytes of the cell header and stores it in the HEC field. On the receive side, the HEC value is calculated again and compared to the stored value. Cells with detected errors are discarded on this basis.

The ATM architecture uses a logical model to describe its functionality. The ATM functionality is analogous to that of the physical layer and part of the data link layer of the well known open systems interconnection (OSI) reference model. The ATM reference model is composed of three ATM layers. First, is the physical layer. The physical layer is analogous to the physical layer of the OSI reference model. The ATM physical layer provides for transmission of electrical/optical signals over the physical transmission medium. Because ATM is ubiquitously well known in the art, a complete discussion of the functionality of the ATM physical layer has been intentionally omitted.

The remaining two layers are the ATM layer and the ATM adaptation layer (AAL). The ATM layer and the AAL combined are roughly analogous to the data link layer of the OSI reference model. The ATM layer is responsible for establishing connections and passing cells through the ATM network using information in the header of each ATM cell. The AAL is responsible for isolating higher-layer protocols from the details of the ATM processes and is therefore of most significance to the present invention. The AAL prepares cells for transmission, preserving their order and encoding all the information sufficient for reassembly of cells at the receiving end. There are four types of adaptation layers: AAL1, AAL2, AAL3/4 and AAL5. AAL5 is the used for data over ATM and is the most widely used AAL type. It is used to transfer most non-SMDS data, such as classical IP over ATM and LAN Emulation. AAL5 is also known as the simple and efficient adaptation layer (SEAL) because the segmentation and reassembly (SAR) sublayer simply accepts the convergence sublayer (CS) protocol data unit (PDU) and segments it into 48-byte SAR-PDUs without adding any additional fields.

AAL5 prepares a cell for transmission in three steps. First, the CS sublayer appends a variable-length pad and an 8-byte trailer to a frame. The pad fills in any additional space in the 48-byte cell boundary if the CS-PDU is less than 48-bytes long. The trailer includes the length of the frame and a 32-bit cyclic redundancy check (CRC-32) computed across the entire PDU. This allows the AAL5 receiving process to detect bit errors, lost cells, or cells that are out of sequence. Secondly, the SAR sublayer of the AAL5 segments the CS-PDU into 48-byte blocks. Finally, the ATM layer places each block into the payload field of an ATM cell. For all cells except the last, a bit in the PT field is set to zero to indicate that the cell is not the last cell in a series of cells that represent a single frame. The PT field of the last cell is set to one.

FIG. 5 is logic model illustrating an AAL5 segmentation/reassembly operation. For purposes of this example, the process of segmentation (on the transmission end) will be discussed, but it should be understood that the process of reassembly (on the receiving end) is substantially the same process performed in the reverse order. In FIG. 5, the model starts with a high level AAL frame 450. The AAL-IDU 450 is converted into a common part convergence sublayer protocol data unit (CPCS-PDU) 440 by the convergence sublayer. This convergence process includes appending a variable length pad 442 and an 8 byte trailer 444 to the frame 450. The size of the pad 442 will typically be determined by calculating a byte remainder after dividing the byte size of the frame by 48 bytes. The trailer 444 includes the total length of the frame and, as discussed above, a CRC-32 error check value to be used by the receiving process to detect errors. For a more detailed discussion of methods of CRC-32 error checking in ATM transmissions, refer to U.S. Pat. No. 6,189,124, hereby incorporated by reference in its entirety.

Next, the SAR sublayer segments the CS-PDU 440 into 48 byte SAR-PDUs 430. In AAL5, the SAR-PDU does not contain any header or trailer. In AAL3/4, a two octet header and octet trailer are also appended. In AAL1, a 1 octet header is appended. For purposes of example, FIG. 5 illustrates segmentation and reassembly for AAL5 transmission. However, those of ordinary skill in the art should appreciate that this invention may be used with AAL1 or AAL3/4, in addition to AAL5, without departing from the spirit or scope of this invention. As shown in FIG. 5, each SAR-PDU 430 contains 48 bytes of data from the CS-PDU-440, with the exception of the last SAR-PDU 430A. The last SAR-PDU 430A, contains the remainder (≦40 bytes) of the CS-PDU 440, the pad, and the CPCS-PDU trailer 444. Each SAR-PDU 430 maps directly into an ATM cell payload 410.

Thus, as seen in FIG. 5, all information necessary for reassembly of the ATM cells is stored in the ATM cell payload itself. The ATM header information is only necessary for cell transmission over the ATM network. Once the cell is received at a DSL modem, the ATM cell header information is not used. The first step upon receiving and re-assembling ATM cells at the end node is to discard the cell header information.

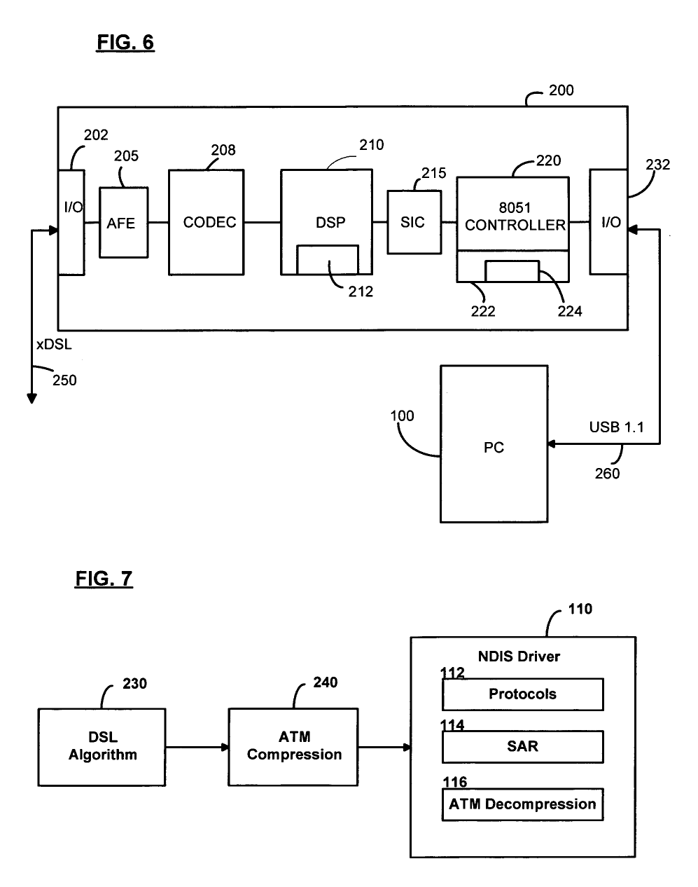

FIG. 6 is a block diagram illustrating an a DSL-based system for achieving improved USB 1.1 channel isochronous downstream data throughput rates between a DSL modem and a PC according to at least one embodiment of this invention. In FIG. 6, a USB compliant DSL modem 200 is communicatively connected to a PC over a USB 1.1 data channel 260. The USB DSL modem 200 is communicatively connected to an ATM network through a local carrier switch (not shown) over a digital subscriber line 250. Typically, both the DSL modem 200 and PC 100 will reside at the user or customer premises.

As seen in FIG. 6, the modem comprises a physical I/O connecter 202 that electrically connects the modem 200 to the digital subscriber line 250. The modem also comprises an analog front end chip (AFE) 205 that provides line interface, receiving the incoming signal and transmitting the outgoing signal from and to the digital subscriber line 250. The AFE 205, which is well known in the art, may include a coder/decoder (CODEC) having such components (not shown) as a digital to analog converter (D/A) and an analog to digital converter (A/D) both of which are also well known in the art. The modem also comprises a DSP chip 210 having a memory 212 for performing signal processing on the signal received by the modem 200 from either the digital subscriber line 250 or from the PC over the USB 1.1 data channel 260. In various exemplary embodiments, the AFE 205 and the DSP 210 are configured on a two-chip digital/analog chipset such as the CENTRAGATE USB ADSL integrated USB chipset manufactured and sold by CONEXANT Systems of Newport Beach, Calif. However, it should be appreciated that other suitable AFEs and DSPs may be mounted on separate chipsets or that other suitable combination AFE/DSP chipsets may be substituted without departing from the spirit or scope of this invention.

The modem 200 also comprises system interface circuitry (SIC) 215 and a controller 220. The SIC operates to interface data signals that are transferred between the DSP 210 and the controller 220. In various exemplary embodiments, the controller 220 comprises a memory 222 containing an algorithm 224 stored therein. During downstream data transfer operations, the controller 220 performs ATM cell header compression on ATM cells received by the modem 220, executing the compression algorithm 224 stored in the memory 222 of the controller 220. In FIG. 6, the controller 220 is shown, for illustrative purposes only, as an 8051-type microcontroller, such as that manufactured and sold by INTEL Corporation of Santa Clara, Calif. However, it should be appreciated that any other microcontroller or processor may be substituted without departing from the spirit or scope of this invention. Finally, the controller 220 is connected to an I/O connector 232 that interfaces with the USB cable 260. As noted above, the controller used to implement the invention may be a programmable microcontroller. However, the controller may be—based on a wide variety of other technologies including a special purpose computer, a computer system including a microcomputer, mini-computer or mainframe for example, a programmed microprocessor, a peripheral integrated circuit element, a CSIC (Customer Specific Integrated Circuit) or ASIC (Application Specific Integrated Circuit) or other integrated circuit, a logic circuit, a digital signal processor, a programmable logic device such as a field programmable gate array (FPGA), programmable logic device (PLD), programmable logic array (PLA) or programmable array logic (PAL), or any other device or arrangement of devices that is capable of implementing the steps of the process of the invention.

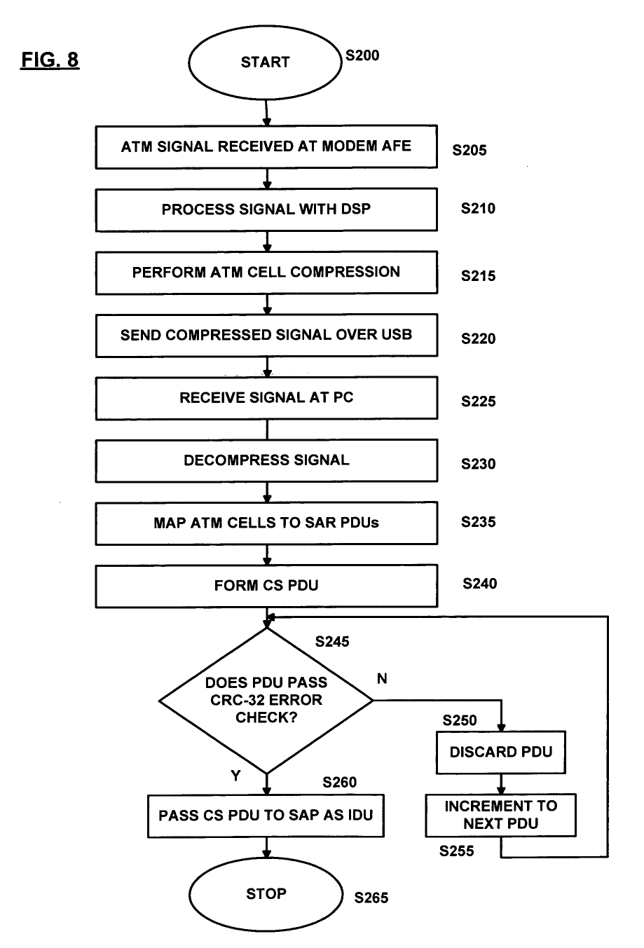

FIG. 7 is a block diagram illustrating software components of a system for providing improved data throughput rates between a DSL modem and a PC over a USB data channel according to at least one exemplary embodiment of this invention. The first component in the system is the DSL module 230. The DSL module 230 represents software instructions or other logic adapted to receive a DSL signal employed by a typical DSL modem. These instructions include any routines performed by a digital signal processor and/or controller to de-format any DSL formatting and to reformat the signal for transmission to a PC over a serial data bus. The next software component in the system of FIG. 7 is the ATM compression component 240. The ATM compression component 240 comprises instructions for performing a header stripping algorithm that effectively compresses the ATM cells prior to transmission over the USB channel. The third component of the system is the network driver interface specification (NDIS) component 110. The NDIS component 110 contains all the software drivers required to perform decompression and reassembly on the ATM cells. The NDIS component 110 is comprised of three basic subcomponents or subroutines: the ATM decompression subcomponent 116, the segmentation and reassembly (SAR) subcomponent 114 and the protocols subcomponent 112. The ATM decompression subcomponent 116 performs the reverse function of the compression component 240. The remaining software subcomponents of the NDIS component 110 are the SAR subcomponent 114 and the protocol subcomponent 112. On data downloads, the SAR subcomponent 114 performs reassembly of the decompressed ATM cells and the protocols subcomponent 112 passes the high level PDU formed by the SAR subcomponent 114 to the appropriate application.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

As described above, the invention may illustratively be embodied in the form of a modem with a controller and computer or computer system executing a decompression algorithm, for example, that includes at least one memory. It is to be appreciated that the set of instructions, i.e., the software for example, that enables both the controller and the computer operating system to perform the operations described above may be contained on any of a wide variety of media or medium, as desired. Further, the data that is processed by the set of instructions might also be contained on any of a wide variety of storage mediums. That is, the particular medium, i.e., the memory in controller and the computer, utilized to hold the set of instructions and/or the data used in the invention may take on any of a variety of physical forms or transmissions, for example. Illustratively, the medium may be volatile and/or non-volatile random access memory, read only memory, a compact disk, a DVD, an integrated circuit, a hard disk, a floppy disk, an optical disk, a magnetic tape, a RAM, a ROM, a PROM, a EPROM as well as any other medium or source of data that may be read by the processors of the invention.

FIG. 8 is a flow chart outlining a method for improving data transfer of ATM cells between a DSL modem and a PC over a USB 1.1 data channel according to various exemplary embodiments of this invention. Operation of the method begins at step S200 and proceeds to step S205 where an ATM signal containing a plurality of ATM cells is received by the AFE of the DSL modem. Next, at step S210, the signals are passed to the DSP for processing and conversion to a serial data stream. Operation of the method then proceeds to step S215 where ATM cell compression is performed by a microcontroller on the ATM cells to strip off the cell header information of the cells. Then, at step S220, the compressed ATM signal is sent to the USB bus.

In step 225, the compressed serialized ATM signal is received by the PC over the USB. Then, in step S230, a software driver stored in the PC causes the processor to execute a series of instructions to decompress the ATM cells. Once the cells are decompressed, the computer may process them as if they were received from modem over the USB channel without compression. At step S235, the decompressed ATM cells are interpreted by the SAR sublayer as SAR protocol data units (PDU). Headers and optionally trailers are also constructed. Next, at step S240, the SAR-PDUs are interpreted by the CPC sublayer and the CS protocol data unit is formed. At step S245, using a CRC-32 error check on the current PDU, a determination is made by the CS layer as to whether the current PDU contains an error. If at step S245 it is determined that the current PDU contains an error, then processing proceeds to step S250. In step S250, the current PDU is discarded and then, at step S255 the process increments to the next PDU and returns to step S245. Otherwise, if at step S245 it is determined that an error has not occurred, then processing proceeds to step S260 where the CS-PDU is passed to the SAP as an interface data unit (IDU). Operation of the method terminates at step S265.

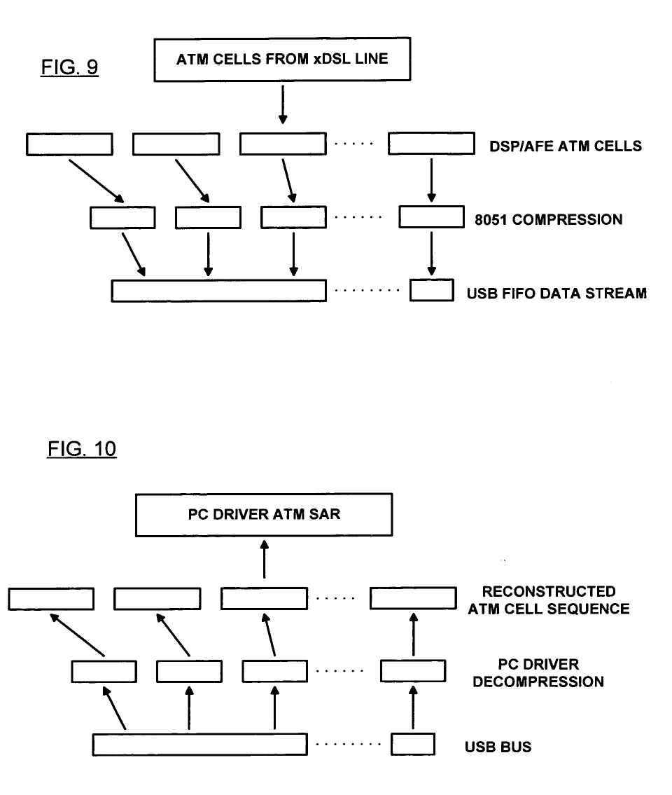

Referring now to FIGS. 9 and 10, these are block diagrams illustrating functional steps of compressing and reassembling an ATM cell in accordance with at least one embodiment of the present invention. The incoming ATM cells arriving over the xDSL line are processed in a typical manner by the internal modem to perform reverse DSL algorithm on the data so that it can be extracted. Then, in a manner consistent with the embodiments discussed herein cell compression is performed on the data to strip the ATM cell headers from the cells. Then, a FIFO data stream is formed from the compressed cells and is transmitted over the USB line to the destination device, such as, for example, a computer. At the destination device the data stream is received over the USB bus. Using software drivers, the destination device performs a decompression of the data in the data stream and traditional segmentation and reassembly are performed so that the data can be delivered to the requesting application, such as, for example, a web browser client.

Other embodiments, uses, and advantages of the invention will be apparent to those skilled in the art from consideration of the specification and practice of the invention disclosed herein. The specification and drawings should be considered exemplary only, and the scope of the invention is accordingly intended to be limited only by the following claims and equivalents thereof.

1. A method for improving isochronous downstream data throughput rates between a DSL modem and a destination device over a USB 1.1 channel, the method comprising:
receiving, at a DSL modem, an ATM formatted signal comprising one or more ATM cells, wherein each of the one or more ATM cells comprises an ATM cell header and an ATM cell payload;
performing, at the DSL modem, ATM cell compression on the one or more ATM cells;
transferring, from the DSL modem, the one or more compressed ATM cells over a USB channel to a destination device;
receiving, at the destination device, the one or more compressed ATM cells; and
decompressing the one or more compressed ATM cells for processing by the destination device.

2. The method according to claim 1, wherein the step of performing ATM cell compression further comprises removing the ATM cell header from each of the one or more ATM cells.

3. The method according to claim 2, wherein the step of performing ATM cell compression further comprises executing instructions to compress the one or more ATM cells.

4. The method according to claim 1, wherein the step of transferring the one or more compressed ATM cells over a USB channel to another device further comprises transferring the ATM cell payload over the USB channel.

5. The method according to claim 1, wherein the destination device is at least one device selected from the group consisting of a personal computer, a personal digital assistant (PDA), palm top computer, a combination computing and communication device, and other computing device.

6. A system for improving isochronous downstream data throughput rates between a DSL modem and a destination device over a USB 1.1 channel comprising:
a DSL modem comprising a processor and operable to receive and transmit digital information over a DSL channel;
a destination device communicatively connected to the DSL modem over a USB 1.1 channel;
the processor operable to execute instructions to compress one or more ATM cells received over the DSL channel, each of the one more ATM cells comprising a cell header and a cell payload;
a connection interface creating an electrical pathway for the compressed ATM cell headers from the processor to the USB channel.

7. The system according to claim 6, wherein the DSL modem further comprises a memory storing the instructions for compressing ATM cells.

8. The system according to claim 7, wherein the instructions to compress one or more ATM cells further comprise instructions for removing the ATM cell header from each of the one or more ATM cells to form compressed ATM cells.

9. The system according to claim 8, wherein the compressed ATM cells comprise ATM cell payloads only.

10. The system according to claim 6, wherein the destination device is at least one device selected from the group consisting of a personal computer, a personal digital assistant (PDA), palm top computer, a combination computing and communication device, and other computing device.

11. The system according to claim 6, wherein the destination device comprises a software decompression driver for decompressing the compressed ATM cells received from the modem over the USB channel.

12. A multi-chip DSL modem chipset for achieving improved isochronous downstream data throughput rates comprising:
an analog chip, comprising an analog front end;
a digital chip, comprising a digital signal processor and a first memory integral to or in communication with the digital signal processor;
a processor executing instructions to compress ATM cell headers;
and a second memory, integral to or in communication with said processor, storing the instructions to compress ATM cell headers; and
a USB 1.1 compliant interface in electrical communication with said processor.

13. A DSL modem for achieving improved isochronous downstream data throughput rates comprising:
a modem housing;
a DSL connection interface integral to one or more surfaces of said modem housing;
a USB connection interface integral to one or more surfaces of said modem housing;
an electrical data path internal to said modem housing, said electrical data path defining a data path from said DSL connection interface to said USB connection interface through internal components of said modem housing;
an analog front end chip internal to said housing and along said electrical data path;
a digital signal processor internal to said housing along said electrical data path;
a microcontroller internal to said housing and along said electrical data path; and
a memory integral to or in communication with said microcontroller; wherein said memory contains a compression algorithm that is executed by said microcontroller to compress ATM cells received by said modem along said electrical data path.

14. A system for achieving improved isochronous downstream data throughput rates between a DSL modem and a destination device over a USB 1.1 data channel, comprising:
means, at a DSL modem, for receiving an ATM formatted data signal over a digital subscribe line (DSL);
means, at the DSL modem, for compressing ATM cells of the ATM formatted data signal;
means, at the DSL modem, for transmitting a USB 1.1 compliant signal comprised of the compressed ATM cells to the destination device;
means, in the destination device, for receiving and decompressing the signal comprised of the compressed ATM cells.

15. The system according to claim 14, wherein the means for compressing ATM cells comprises a processor executing a compression algorithm stored in the DSL modem.

16. The system according to claim 14, wherein the processor comprises a microcontroller.

17. The system according to claim 14, wherein the destination device is at least one device selected from the group consisting of a personal computer, a personal digital assistant (PDA), palm top computer, a combination computing and communication device, and other computing device.

18. The system according to claim 14, wherein the means for receiving and decompressing the signal comprised of the compressed ATM cells comprises one or more software drivers stored in a storage device of the destination device.

19. A system for achieving improved isochronous downstream data throughput rates between a DSL modem and a destination device over a USB 1.1 data channel comprising:
a DSL modem having a processor and a computer readable storage medium contained therein, said storage medium storing instructions for causing said processor to perform compression on ATM cells received by said modem;
a USB compliant interface communicatively connected to said processor for transmitting a signal comprised of compressed ATM cells over a USB 1.1 data channel;
a destination device communicatively connected to said modem by the USB 1.1 data channel;
a computer readable storage medium integral to or in communication with said destination device, said storage medium storing computer readable instructions therein for causing said computer to perform a decompression algorithm on said signal.
